(19) United States
(12) Patent Application Publication
(10) Pub. No.: US 2016/0036367 A1
(43) Pub. Date: Feb. 4, 2016

(54) VARIABLE SPEED GENERATOR AND MOTOR

(71) Applicant: Innovus Power, Inc., Freemont, CA (US)

(72) Inventors: John MCCALL, Freemont, CA (US); Brendan TAYLOR, Freemont, CA (US); Mark PRESTON, Freemont, CA (US)

(73) Assignee: Innovus Power, Inc., Freemont, CA (US)

(21) Appl. No.: 14/812,685

(22) Filed: Jul. 29, 2015

Related U.S. Application Data
(60) Provisional application No. 62/030,365, filed on Jul. 29, 2014.

(51) Int. Cl. H02P 25/30; H02P 9/04; H02P 27/06

(52) U.S. Cl. CPC H02P 25/30; H02P 27/06; H02P 9/04

(57) ABSTRACT

A system for supplying power to a motor driven pump. The system includes a variable speed electrical generator driven by an engine and a variable frequency drive connected to the output of the generator. The motor is powered by the output of the variable frequency drive. The system also includes a controller for changing the frequency of the output of the variable frequency drive and thereby changing the speed of the motor and the pump.

### CROSS-REFERENCE TO RELATED APPLICATIONS

The present application claims priority to and the benefit of U.S. Provisional Patent Application No. 62/030,365, filed Jul. 29, 2014. The foregoing provisional application is incorporated by reference herein in its entirety.

### BACKGROUND

Electrical networks that are isolated from the larger electrical “grid”, may be referred to as microgrids. In these microgrids, it is common to have multiple engine-generator sets (usually diesel engines), or gensets providing power to the microgrid. See, for example, U.S. Published Patent Application No. 2014-0097683 (incorporated by reference herein). The gensets can run independently, or in parallel. The process of determining which genset(s) to run at any given time, and how to share load among them when running in parallel, is commonly called “dispatching”. In a microgrid, it is often the case that a genset must be run at relatively low load in order to prepared to provide enough generation capacity to handle a large, sudden increase in load. This extra capacity is called spinning reserve. If renewable energy sources are included in the microgrid, even more spinning reserve may be required to account for the additional variability of the “net load” (actual load minus renewable power contribution).

A fixed-speed gensets (FSG) is less efficient when running significantly below rated power, and this can also lead to maintenance and emissions issues due to lower-temperature combustion at lower load. The need for spinning reserve can lead to lower fuel efficiency and increased maintenance in microgrids which are powered by only fixed-speed gensets.

A variable speed genset (VSG) can run at relatively low loads with much better efficiency and emissions, and lower maintenance costs, than a FSG. Furthermore, it is sometimes the case that the total system fuel efficiency, which is the combined fuel efficiency of all operating gensets in a microgrid, can be improved by shifting load away from the VSG(s) toward the FSG(s), which might not yield the best fuel efficiency result for the VSG when considering it alone. Thus, there is a need to find the optimum dispatch that maximizes system fuel efficiency when a VSG is included in a microgrid.

Microgrids may be used to provide power to components in remote locations that do not have access to the conventional grid. For example, in many oil production sites, is no electric grid available to supply power. In this situation, it is common to use a fixed speed engine-generator set (genset) to supply power for a pump used in oil production. In some cases an inverter (i.e., a variable frequency drive (VFD)) is used between the genset and the pump to provide a range of pump speed, and/or to reduce large in-rush currents when the pump starts. However, when the pump load is significantly below rated output of the fixed frequency genset, the fuel efficiency is reduced, emissions are worse and maintenance is increased due to reduced combustion quality.

### BRIEF DESCRIPTION OF THE DRAWINGS

Features, aspects and advantages of the present invention will become apparent from the following description and the accompanying exemplary embodiments shown in the drawings, which are briefly described below.

FIG. 1 is a block diagram of an exemplary power supply system for a pump.

FIG. 2 is a block diagram of an exemplary power supply system for a pump.

### DETAILED DESCRIPTION

This application discloses a system and method for employing the combination of a variable speed engine-generator set and an electric pump connected through a full power converter that allows the engine to run at its optimum speed for the given load conditions, and allows the pump to run at an independent speed. This application discloses two methods for optimizing total system fuel efficiency of a system of engine-generator sets (gensets) that includes at least one variable speed genset, which can be operated independently or in parallel with the ability to share load in any proportion.

The first method of optimizing total system fuel efficiency uses a technique known as “perturb and observe,” where, for a particular load condition, the load distribution among the gensets is changed slightly from the currently stored set point in a particular direction within the search space (perturb). Then, the system is observed to see if there is improvement in performance. If “yes” (i.e., performance improves), the currently stored set point is updated with the new value. The process is repeated until the maximum performance is found for the given load condition, and for a finite number of steps in load condition. In this way the system is always optimized even if performance conditions within the system change (e.g. an engine is rebuilt).

The first method may be more applicable to a s system utilizing a smaller number of gensets (e.g., two or three). The first method, which can be referred to as a Perturb and Observe system, starts with an estimated dispatch algorithm calculated from load data collected prior to installation of this system. In addition to fuel efficiency, there are many other factors that could be considered when determining which gensets to operate. For example, the following factors could be considered: the expected and/or actual load at this time; the expected and/or actual variability of the load at this time; the largest step load in the system; if a renewable power source in the system, the output and variability of the renewable power source. After determining which gensets need to be operated to meet the load requirements, the optimum load sharing must still be determined

The perturb and observe method may be described with reference to the following example. For example, a system is provided with two gensets. The first genset is a 1000-kW fixed-speed genset (G1), and the second genset is a 750-kW variable speed genset (G2). An examplery load condition exists on the system. For example, the present load condition is 1200 kW on average with a small amount of variability. The range of possible load distributions among the two gensets, is bounded by the maximum output of each genset:

G1=1000 kW, G2=200 kW

G1=450 kW, G2=750 kW

If the present distribution for this load is set at G1=900 kW and G2=300 kW, then the system may be “perturbed” so that the new load condition might be G1=925 kW and G2=275 kW. The system is observed and, if it is found that this load sharing condition improves the overall system efficiency, then this load distribution becomes the new distribution set point for 1200 kW load. This two genset example is essentially a one-dimensional search space.

If the system has three gensets, it becomes a two-dimensional search space. For a given load, the perturb and observe “test” would include, for example, the following conditions:

1) altering the distribution of load between G1 and G2 while holding G3 steady, and

2) altering the distribution of load between G1 and G3 while holding G2 steady.

In this way, the control system finds the local gradient of the search space, and moves in the “most uphill” (i.e., adjusts the load in a way to cause the largest relative perturbation) direction with each test iteration until the local maximum is found. The method determines a load distribution based on a local maximum efficiency which may not correspond to a global maximum efficiency.

The second method of optimizing total system fuel efficiency uses an online model, which includes a more complete set of considerations, such as fuel price, actual maintenance costs and historical load data, to determine the optimum dispatch of gensets. The online model is continuously updated with real operating data so that its solution reflects changes in the system for which it is used. The second method utilizes a mode that is available to the control system in real time and can be used to make control decisions, that is designed to “learn” from real-time operating data, includes a more complete economic model, and may be more appropriate for complex systems that include three or more gensets.

The second method, may be referred to as the Online Learning Model (OLM) method, is used to solve the same dispatch problem for a system of three or more gensets. The OLM includes the use of an online model (i.e. one that is available to the control system in real-time, allowing it to make control decisions based on modeling results). The system is modeled more completely, including economic factors such as price of fuel and maintenance costs, and is constantly updated with real data from the system (e.g. load data, engine run hours, etc.), thereby “learning” about the actual system and adjusting its dispatch result accordingly. Since this is computationally intensive, the model is run on a separate computer from the control system or, alternatively, even on a different network, but to which the control system has access.

Thus, an improved power system is provided; a power system supplied by a plurality of gensets, at least one of the gensets is a variable-speed genset, in which the optimum dispatch for each load condition is continuously updated by changing the load distribution slightly, testing for performance improvement and updating the distribution set points if improvement is found. Alternatively, the power system may be controlled so that the optimum dispatch for each load condition is determined with the use of an online model that is continuously updated with actual operational data to improve the accuracy of the model and thereby the optimum dispatch.

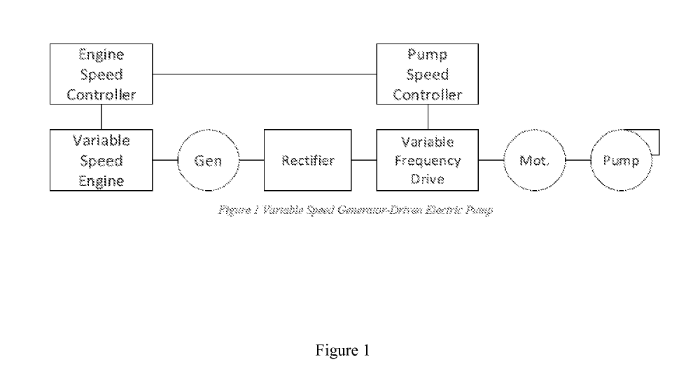

A system for determining the optimum speed for operating the engine of the variable speed generator set is also disclosed. For example, for a system including a single genset (such as shown in FIG. 1), the engine may run at its optimum speed for the given load because the active rectifier converts the variable frequency/variable voltage AC from the generator to DC. The VFD converts the DC power into AC at the frequency required to drive the pump at the desired speed. In this configuration, the Engine Speed Controller (ESC) (which may include a microprocessor) determines the optimum speed for the engine using the method described in U.S. Provisional Patent Application Ser. No. 62/007,736, titled A Method For Tracking the Maximum Efficiency Point of a Variable Speed Engine-Generator Set (incorporated by reference herein). The ESC may control the engine throttle position, for example, in order to control the speed of the engine.

According to this method, the ESC is loaded with an initial set of operating points, or a “load-speed curve”, which consist of a speed set point for a corresponding power output. As the system operates and encounters a particular load condition, it uses a “perturb and observe” method to try a new speed set point, see if it improves the fuel efficiency of the engine, and if yes, updates the load-speed curve. For example, at a load of 500 kW the current speed set point is 1400 RPM, according to the load-speed curve. The next time an average load of 500 kW is encountered for a sustained period of e.g. one minute, the speed set point is reduced to 1375 RPM. If the fuel efficiency is seen to improve at this new speed, the load-speed curve is updated to use 1375 RPM instead of 1400 RPM. If the fuel efficiency worsens, the next time a 500 kW load is encountered, the ESC will try 1425 RPM. If this is found to improve efficiency, then 1400 RPM is replaced with 1425 RPM in the load-speed curve; if not, then 1400 RPM remains as the speed set point for 500 kW load.

Since the engine's efficiency can change over time as components degrade, or are replaced, and possibly from unit to unit, this search algorithm may be continuously applied throughout the life of the system, thus ensuring that the engine is always running at its optimum efficiency. In the system described in FIG. 1, the Pump Speed Controller (PSC) sets the Variable Frequency Drive (VFD) speed for the application requirements. It is important to note that the VFD shown in FIG. 1 includes line filters that improve the quality of the power delivered to the pump motor by reducing harmonic content.

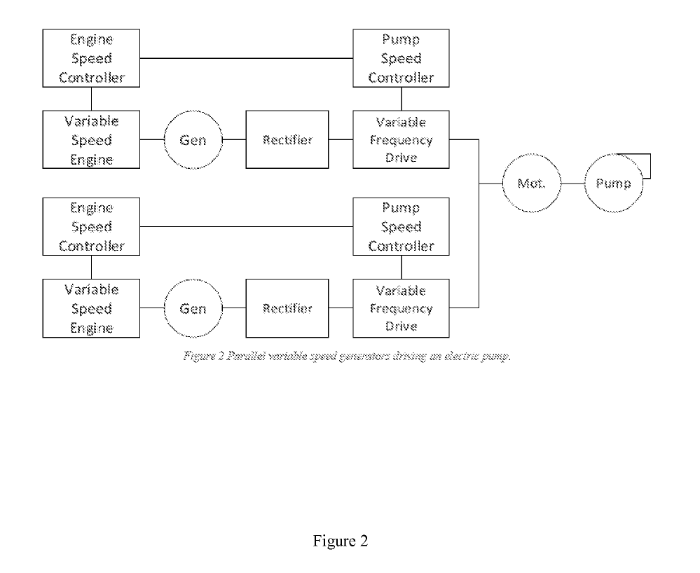

In an alternative embodiment, shown in FIG. 2, The system includes two variable speed generators operating in parallel, driving the pump. In some applications it is desirable to have redundancy so that if one power source fails the other can carry the load, or at least part of the load, until it is repaired or replaced. In FIG. 2, both of the variable frequency drives are connected to an electrical grid (i.e., microgrid) that provides power to the pump motor.

Thus, a system is disclosed that includes a variable speed engine-generator set electrically connected to a full power converter, with the inverter side of the converter electrically connected to an electric motor that is mechanically connected to a pump, whereby the speed of the electric pump is set by the output frequency of the inverter, and is optimized to the pumping application, and the speed of the engine is independently optimized to maximize fuel efficiency. The system may include an additional variable speed engine-generator set and full power converter connected in parallel, both supplying power to a single electric motor and pump.

For purposes of this disclosure, the term “coupled” means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components or the two components and any additional member being attached to one another. Such joining may be permanent in nature or alternatively may be removable or releasable in nature.

It is important to note that the system and methods disclosed herein are exemplary embodiments and intended to be illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter disclosure herein. For example, elements shown as integrally formed may be constructed of multiple parts or elements, the position of elements may be reversed or otherwise varied, and the nature or number of discrete elements or positions may be altered or varied. Accordingly, all such modifications are intended to be included within the scope of the present application. The order or sequence of any process or method steps may be varied or re-sequenced according to alternative embodiments. Other substitutions, modifications, changes and omissions may be made in the design, operating conditions and arrangement of the exemplary embodiments.

What is claimed is:

1. A system for supplying power to a motor driven pump comprising:
a variable speed electrical generator driven by an engine;
a variable frequency drive connected to the output of the generator;
wherein the motor is powered by the output of the variable frequency drive; and
a controller for changing the frequency of the output of the variable frequency drive and thereby changing the speed of the motor and the pump.

2. The system of claim 1 further comprising a rectifier connected to the output of the generator and the input of the variable frequency drive, wherein the variable frequency drive converters the DC output of the rectifier into an AC power supply for the motor.

3. The system of claim 2, wherein the rectifier is an active rectifier.

4. The system of claim 1, further comprising a controller for controlling the speed of the engine, wherein the controller controls the speed of the engine to optimize fuel efficiency.

5. The system of claim 3, wherein when the operation of the motor creates a particular load condition on the engine the controller is configured to change the speed of the engine to a new speed and to monitor the fuel efficiency of engine at the new speed; and wherein the controller is configured to determine whether the fuel efficiency of the engine is improved at the new speed and, if the fuel efficiency of the engine is improved, to control the engine to operate at the new speed if the engine encounters the particular load condition in the future.

6. The system of claim 1, further comprising an electrical grid, wherein the motor and the variable frequency driver are connected to the electrical grid and wherein a second variable frequency drive is connected to the electrical grid.

7. The system of claim 6, further comprising a second variable speed generator connected to the second variable frequency drive by a second rectifier.

8. The system of claim 7, wherein the second rectifier is an active rectifier.

9. The system of claim 8, further comprising a pump controller for controlling the frequency of the output of the second variable frequency drive.

10. A system for supplying power to a motor driven pump comprising:
at least two variable speed electrical generators, wherein each of the generators is driven by an engine;
wherein the output of each of the generators is connected to an active rectifier;
wherein the output of each of the active rectifiers is connected to a variable frequency drive that is connected to an electrical grid that supplies power to the motor; and
wherein a controller adjusts the frequency of the output of each of the variable frequency drives in order to control the speed of the motor.

11. The system of claim 10, further comprising an engine speed controller for controlling the speed of each of the engines, wherein the controller controls the speed of the engines to optimize fuel efficiency.

12. The system of claim 11, wherein when the operation of the motor creates a particular load condition on the engines the engine speed controller is configured to change the speed of the engines to a new speed and to monitor the fuel efficiency of engine at the new speed; and wherein the controller is configured to determine whether the fuel efficiency of the engines is improved at the new speed and, if the fuel efficiency of the engine is improved, to control the engine to operate at the new speed if the engine encounters the particular load condition in the future.

13. The system of claim 12, wherein the electrical load is distributed between each of the variable speed generators based

14. A system for supplying power to a motor driven pump comprising:
a variable speed electrical generator driven by an engine;
an active rectifier connected to the output of the electrical generator;
a variable frequency drive connected to the output of the rectifier;
wherein the motor is powered by the output of the variable frequency drive; and
a first controller for changing the frequency of the output of the variable frequency drive and thereby changing the speed of the motor and the pump.

15. The system of claim 14, further comprising a second controller for controlling the speed of the engine, wherein the second controller changes the speed of the engine to optimize fuel efficiency.

16. The system of claim 15, wherein when the operation of the motor creates a particular load condition on the engine the second controller is configured to change the speed of the engine to a new speed and to monitor the fuel efficiency of engine at the new speed; and wherein the second controller is configured to determine whether the fuel efficiency of the engine has increased at the new speed and, if the fuel efficiency of the engine is increased, to control the engine to operate at the new speed if the engine encounters the particular load condition in the future.
